(19) United States
(12) Patent Application Publication
(10) Pub. No.: US 2019/0384771 A1
(43) Pub. Date: Dec. 19, 2019

(54) EXTRACTING DEVICE, EXTRACTING METHOD AND STORAGE MEDIUM, AND ABNORMALITY DETECTING DEVICE AND ABNORMALITY DETECTING METHOD

(71) Applicant: NEC Corporation, Minato-ku, Tokyo (JP)

(72) Inventor: Moyuru KURITA, Tokyo (JP)

(73) Assignee: NEC Corporation, Minato-ku, Tokyo (JP)

(21) Appl. No.: 16/478,900

(22) PCT Filed: Jan. 19, 2018
(86) PCT No.: PCT/JP2018/001491

§ 371 Date: Jul. 18, 2019

(30) Foreign Application Priority Data
Jan. 19, 2017 (JP) 2017-007835

(51) Int. Cl. G06F 16/25; H04L 12/28; G06F 3/0482; H04L 29/06; B60R 16/023; H04W 88/18; H04L 12/18

(52) U.S. Cl. CPC G06F 16/254; H04L 12/28; G06F 3/0482; H04L 12/1881; B60R 16/023; H04W 88/184; H04L 63/0414

(57) ABSTRACT

An extracting device includes at least one memory configured to store instructions and at least one processor configured to execute the instructions to generate a predetermined-value set of the predetermined value that appears at the same appearance intervals, based on a predetermined value identifying a message and an appearance interval of the predetermined value that is derived from a timestamp of the message. The at least one processor configured to execute the instructions to extract a predetermined-value sequence indicating a sequence of the messages from the predetermined-value set.

### TECHNICAL FIELD

The present invention relates to an extracting device, an abnormality detecting device, and the like.

### BACKGROUND ART

With an increase of functions of an automobile, the number of electronic control units (ECUs) installed in an automobile is increasing. ECUs of this type are connected to an in-vehicle local area network (LAN) that conforms to controller area network (CAN), which is an in-vehicle communication protocol, and relay transmission and reception of messages between the ECUs.

In recent years, opportunities for an automobile to communicate with an external network have increased, as in a car-navigation system. On the other hand, a possibility that an automobile may be targeted for hacking attacks and may activate an operation that is not intended by a driver due to rewriting of an internal program is pointed out. In order to prevent such an attack, there is an approach that focuses attention on periodicity of a specific message flowing through an in-vehicle network, and detects a state in which the specific message is flowing through the network at certain periodic intervals, as a normal state, and a change in the periodicity of the message, as an abnormal state (PTL 1).

Further, there is an approach of detecting an abnormality that focuses attention on a sequence of messages, in addition to periodicity of a message (NPL 1). NPL 1 is an approach that takes advantage of a fact that messages flow through an in-vehicle network from ECUs in a predetermined sequential relation according to driver's driving behavior, and detects a change in the sequence of the messages, as an abnormal state.

### CITATION LIST

### Patent Literature

[PTL 1] Japanese Unexamined Patent Application Publication No. 2014-146868

### Non Patent Literature

[NPL 1] Soohyun Ahn et al. “A Countermeasure against Spoofing and DoS Attacks based on Message Sequence and Temporary ID in CAN”, SCIS 2016 (2016 Symposium on Cryptography and Information Security, Jan. 19-22, 2016), The Institute of Electronics, Information and Communication Engineers

### SUMMARY OF INVENTION

### Technical Problem

On the other hand, the approach in NPL 1 assumes that a sequence of messages is known, and information about the sequence of messages needs to be obtained as previous knowledge. However, detailed specifications of messages are not always released to public, and a sequence of messages is sometimes unknown. In such a case, abnormality detection cannot be performed using a sequence of messages.

An object of the present invention is to provide an extracting device and the like that extract a sequence of messages from a message log. Alternatively, an object of the present invention is to provide an abnormality detecting device and the like that are capable of detecting an abnormality of a message even in a message log in which a sequence of messages is unknown.

### Solution to Problem

One aspect of an extracting device according to the present invention includes:

an interval analysis means for, based on a predetermined value identifying a message and an appearance interval of the predetermined value that is derived from a timestamp of the message, generating a predetermined-value set of the predetermined value that appears at the same appearance intervals; and a sequence extracting means for extracting a predetermined-value sequence indicating a sequence of the messages from the predetermined-value set.

One aspect of an extracting method according to the present invention includes:

based on a predetermined value identifying a message and an appearance interval of the predetermined value that is derived from a timestamp of the message, generating a predetermined-value set of the predetermined value that appears at the same appearance intervals; and extracting a predetermined-value sequence indicating a sequence of the messages from the predetermined-value set.

One aspect of an extraction program according to the present invention, the program causing a computer to execute:

based on a predetermined value identifying a message and an appearance interval of the predetermined value that is derived from a timestamp of the message, generating a predetermined-value set of the predetermined value that appears at the same appearance intervals; and extracting a predetermined-value sequence indicating a sequence of the messages from the predetermined-value set.

One aspect of an abnormality detecting device according to the present invention, includes

the above extracting device and;

a checking device, wherein

the checking device includes a sequence checking means for checking whether a sequence of a predetermined value of a message to be checked satisfies the predetermined-value sequence extracted by the extracting device.

One aspect of an abnormality detecting method according to the present invention, includes:

extracting the predetermined-value sequence by the above extracting method; and

checking whether a sequence of a predetermined value of a message to be checked satisfies the predetermined-value sequence.

One aspect of an abnormality detecting system according to the present invention includes a plurality of nodes that transmit messages and the abnormality detecting device described above.

### Advantageous Effects of Invention

An extracting device according to the present invention is capable of extracting a sequence of messages from a message log. Further, an abnormality detecting device according to the present invention is capable of detecting an abnormality of a message even in a message log in which a sequence of messages is unknown.

### BRIEF DESCRIPTION OF DRAWINGS

FIG. 1 is a block diagram illustrating a configuration of an extracting device according to a first example embodiment.

FIG. 2 is a diagram illustrating one example of a message log.

FIG. 3 is a diagram illustrating examples of ID sets classified by appearance intervals.

FIG. 4 is a diagram illustrating examples of time-series periods taken out from an ID set.

FIG. 5 is a diagram illustrating examples of set time-series periods 1 to 3.

FIG. 6 is a diagram illustrating matrices of directed graphs in which IDs in each time-series period are represented by vertices.

FIG. 7 is a diagram illustrating a matrix of a graph of a normal state and a matrix of a graph excluding redundant data.

FIG. 8 is a diagram illustrating examples of ID sequence sets indicating sequential relations among message IDs.

FIG. 9 is a flowchart illustrating an operation of the extracting device according to the first example embodiment.

FIG. 10 is a flowchart illustrating an operation of predetermined-value set generation processing according to the first example embodiment.

FIG. 11 is a flowchart illustrating an operation of predetermined-value sequence extraction processing according to the first example embodiment.

FIG. 12 is a block diagram illustrating a configuration of an abnormality detecting device according to a second example embodiment.

FIG. 13 is a flowchart illustrating an operation of the abnormality detecting device according to the second example embodiment.

FIG. 14 is a configuration diagram illustrating a configuration of an abnormality detecting system according to a third example embodiment.

FIG. 15 is a block diagram illustrating a configuration of an abnormality detecting device according to the third example embodiment.

FIG. 16 is a flowchart illustrating an operation of an interval analysis unit according to the third example embodiment.

FIG. 17 is a flowchart illustrating an operation of a sequence extracting unit according to the third example embodiment.

FIG. 18 is a flowchart illustrating an operation of a checking device according to the third example embodiment.

FIG. 19 is a block diagram illustrating an example of application of an abnormality detecting device to a network system.

FIG. 20 is a block diagram illustrating a hardware configuration, which achieves by a computer, of the extracting device according to any of the first to third example embodiments and the checking device and the abnormality detecting device according to any of the second and third example embodiments.

### EXAMPLE EMBODIMENT

### First Example Embodiment

An extracting device according to a first example embodiment will be described by using drawings. The extracting device according to the first example embodiment is an example that focuses attention on messages transmitted periodically individually by nodes on a network that are contained in a message log in which sequences of messages are unknown and derives a sequential relation among messages from a set of messages that an appearance interval is same.

One aspect of the extracting device according to the first example embodiment will be descried by using drawings. In the first example embodiment, an example will be described in which the extracting device extracts a sequence of message from a message log.

It is assumed in the description of the first example embodiment that messages are broadcasted from a plurality of nodes connected to a network and do not simultaneously flow on the network. A message log is a history of messages transmitted by each node. It is assumed that the message log contains messages transmitted from each node at constant intervals. Further, it is assumed that a sequential relation among the messages in the message log is unknown.

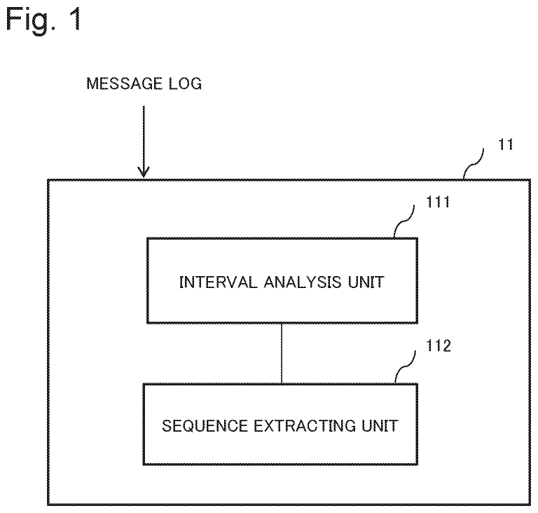

FIG. 1 is a block diagram illustrating a configuration of the extracting device according to the first example embodiment. The extracting device 11 illustrated in FIG. 1 includes an interval analysis unit 111 and a sequence extracting unit 112. The interval analysis unit 111 and the sequence extracting unit 112 will be described below in detail.

The interval analysis unit 111 has a function of generating a predetermined-value set of a predetermined value that appear at a same appearance intervals, based on a predetermined value identifying a message from a message log and the appearance interval of the predetermined value that is derived from timestamp of the message.

One example of a predetermined value identifying a message is a message identifier (ID). Note that the predetermined value identifying the message may be, instead of a message ID, an integer that is an abstraction of combination of a message ID and a message data, for example. Further, the combination is not limited to a message ID and data, but may be a combination of a destination (address) and data, a combination of a command and data, or a combination of data A and data B. In the following description of the first example embodiment, an example will be described in which a message ID is used as a predetermined value identifying a message.

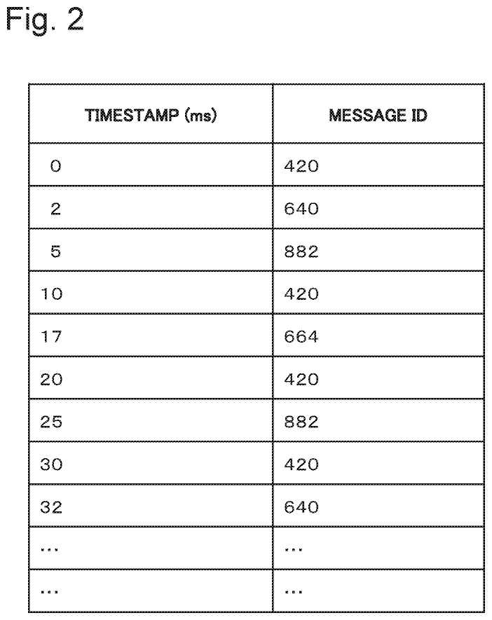

FIG. 2 is a diagram illustrating one example of the message log. The message log contains a timestamp and a message ID (hereinafter sometimes simply referred to as ID). The message ID is an identifier that identifies a message. The timestamp in FIG. 2 is an elapsed time (ms) from arrival of a first massage, and is recorded for each message ID.

The interval analysis unit 111 checks whether there is a message that an appearance interval is same in the message log. Specifically, the interval analysis unit 111 first checks whether there is a duplicated message ID in the message log. When there is a duplicated message ID, the interval analysis unit 111 calculates an appearance interval of the message ID from the elapsed time indicated by the timestamp of the duplicated message ID. Preferably, a margin for a calculation error of the appearance interval of the message ID is taken into consideration.

For example, in the message log illustrated in FIG. 2, an appearance interval of message ID 420 (hereinafter simply denoted as ID 420) is 10 ms. The interval analysis unit 111 calculates an appearance interval of each of the message IDs contained in the message log in series, and generates ID set into which the message ID is classified each by the same appearance interval.

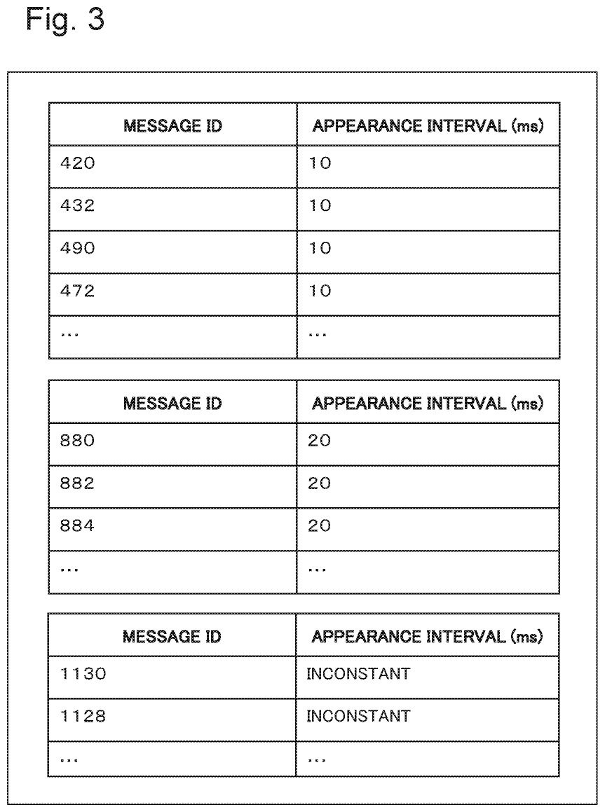

FIG. 3 is a diagram illustrating one example of ID sets classified by appearance intervals. In FIG. 3, message IDs {420, 432 490, 472, . . . } are generated as an ID set having an appearance interval of 10 ms, and message IDs {880, 882, 884, . . . } are generated as an ID set having an appearance interval of 20 ms. The messages having an appearance interval of 10 ms and the messages having an appearance interval of 20 ms can also be referred to as messages having a constant appearance interval. Note that message IDs having different appearance interval are classified as inconstant, as illustrated as ID 1130 and ID 1128 in FIG. 3. Generation of ID set by the interval analysis unit 111 is preferably performed in a state that the number of messages in the message log is greater than or equal to a predetermined quantity (for example greater than or equal to 1000).

The sequence extracting means 112 has a function of extracting a predetermined-value sequence indicating a sequence of messages, from a predetermined-value set. Specifically, the sequence extracting unit 112 sets a plurality of time-series periods from a predetermined-value set, based on the number of identified predetermined values include in the predetermined-value set, and extracts a predetermined-value sequence that is common to the plurality of time-series periods. For example, the sequence extracting unit 112 sets a plurality of time-series periods from an ID set having the same appearance interval among ID sets generated by the interval analysis unit 111, and extracts an ID sequence common to the plurality of set time-series periods.

Details of the sequence extracting unit 112 will be described below. The sequence extracting unit 112 selects one ID set having an appearance interval from among ID sets classified by appearance interval. For example, the sequence extracting unit 112 selects an ID set having an appearance interval of 10 ms from among the ID sets classified by appearance interval illustrated in FIG. 3. When n kinds of message IDs are included in the selected ID set having the appearance interval, the sequence extracting unit 112 sets a plurality of time-series periods in such a way that a series of n message IDs (n is an integer greater than or equal to 2) among the ID sets is set as one time-series period and the same message ID is at the beginning of each of the plurality of time-series periods.

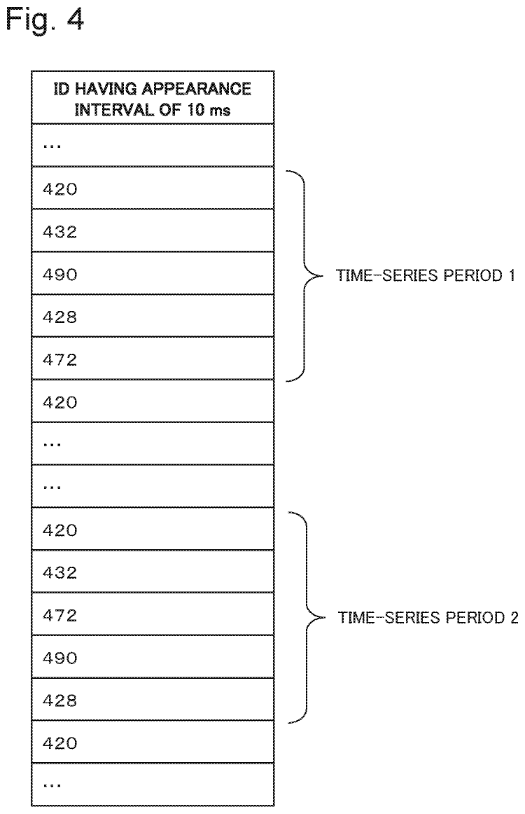

FIG. 4 is a diagram illustrating examples of time-series periods taken out from an ID set. In the example in FIG. 4, there are five kinds of message IDs having an appearance interval of 10 ms, and time-series period which time-series periods 1 and 2 have message ID 420 at their beginning are taken out. The number of time-series periods may be more than three, and the accuracy of an ID sequence extracted by the sequence extracting unit 112 increases as the number of time-series periods increases.

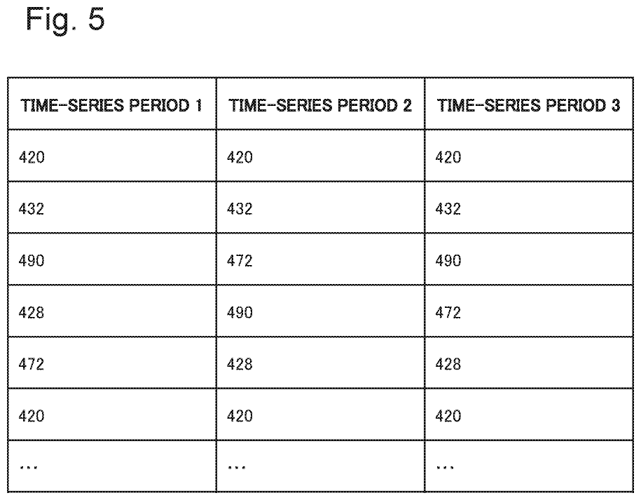

The sequence extracting unit 112 has a function of extracting a predetermined-value sequence indicating a sequence of messages from a predetermined-value set, by using a directed graph in which a predetermined value in a time-series period is represented by vertex and a sequence of predetermined value is represented by edge. A procedure for the sequence extracting unit 112 to extract an ID sequence from a plurality of time-series periods will be specifically described below by using time-series periods 1 to 3 illustrated in FIG. 5. FIG. 5 is a diagram illustrating examples of time-series periods 1 to 3 taken out from an ID set having the same appearance interval. In the example in FIG. 5, there are five kinds of IDs in the ID set, and the common ID at the beginning of the time series periods 1 to 3 is set as 420. Note that it is assumed that the time-series periods 1 to 3 are examples taken out from an ID set having an appearance interval of 10 ms.

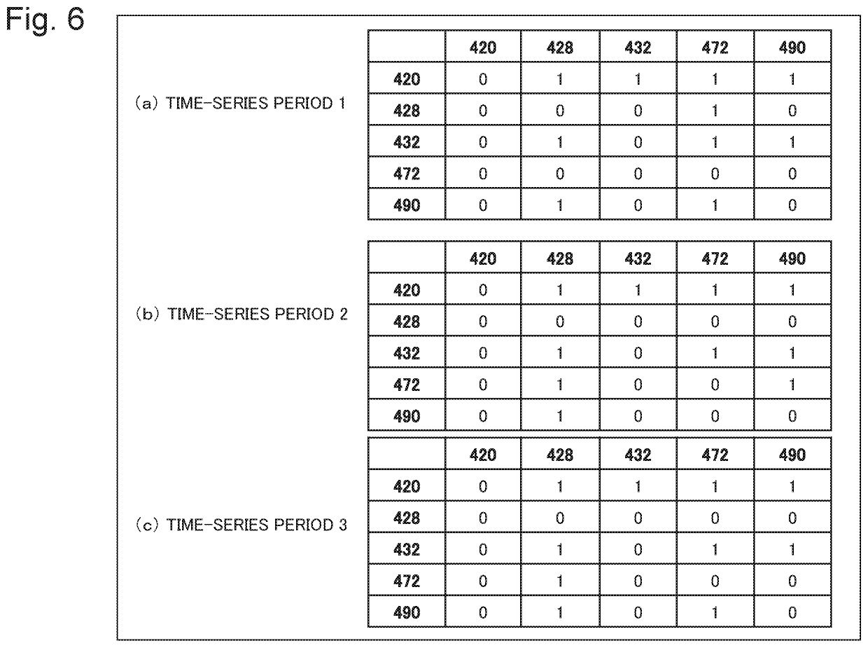

Herein, a sequence of IDs in one time-series period can be represented as a directed graph in which an ID is represented by a vertex and a sequence between each of the IDs is represented by an edge directed toward the vertex. FIG. 6 is a diagram in which directed graphs of the time-series periods 1 to 3 are represented in the form of matrices. In FIG. 6, when a row ID exists before a column ID, the matrix element is set as 1, and when row ID exists after a column ID, the matrix element is set as 0. Note that when a row ID and a column ID are identical to each other, the matrix element is set as 0. For example, in the history in the time-series period 1, because ID 490 exists before ID 472, the matrix element in row 490 and column 472 is 1, whereas the matrix element in column 472 and row 490 is 0. Other matrix elements and matrix elements corresponding to other time-series periods are defined in a similar way.

Then, a state in which a sequence of IDs is maintained in a plurality of time-series periods is considered to be a normal state, and a directed graph of the normal state is defined in the form of the logical product of matrix elements of three time-series periods. Herein, the fact that the element in row 490 and column 428 is 1 means that ID 490 always exists before ID 428 in the sequence of ID 490 and ID 428. Because of this fact, it is determined that, in the normal state, this sequence is always maintained. Note that in the more time-series periods, the lower the probability that a matrix element component in a graph of the normal state will be 1 by chance.

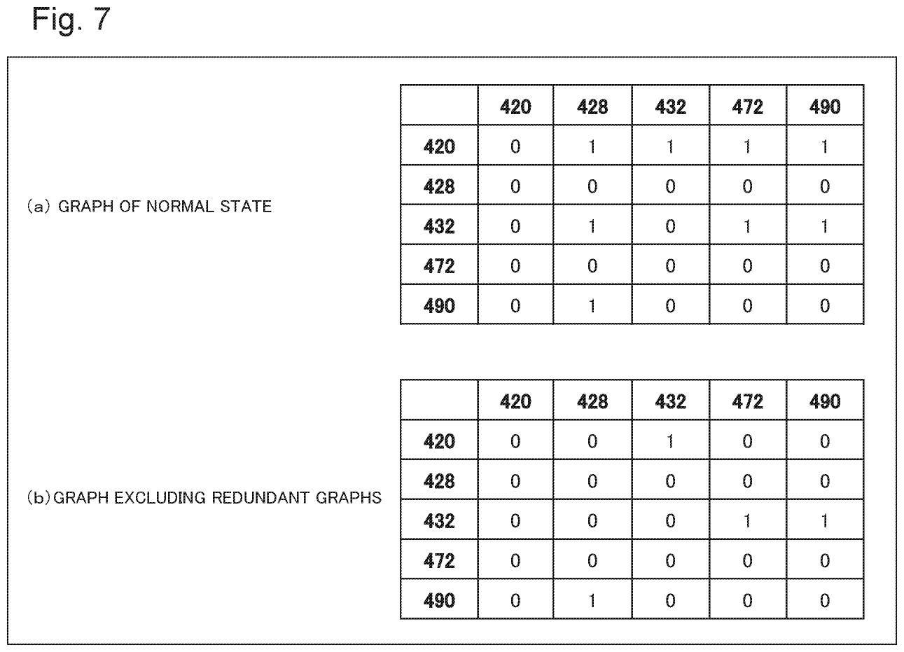

Lastly, redundant matrix elements are removed from the matrix representation of the graph indicating the normal state. FIG. 7 is a diagram illustrating a matrix of a graph of a normal state and a matrix of a graph excluding redundant data. In the matrix representation of the normal state illustrated in the example, an element in row 432 and column 428 is 1, which indicates that ID 432 appears before ID 428. Because both of an element in row 432 and column 490 and an element in row 490 and column 428 are 1, it is obvious that ID 432 precedes ID 428, and an element in row 432 and column 428 does not need to be set as 1.

In the matrix representation illustrated in FIG. 7, only an element in row 420 and column 432, an element in row 432 and column 472, the element in row 432 and column 490, and the element in row 490 and column 428 are 1. Extraction of a path in which an ID sequence that is common to the time-series periods 1 to 3 is maintained becomes possible.

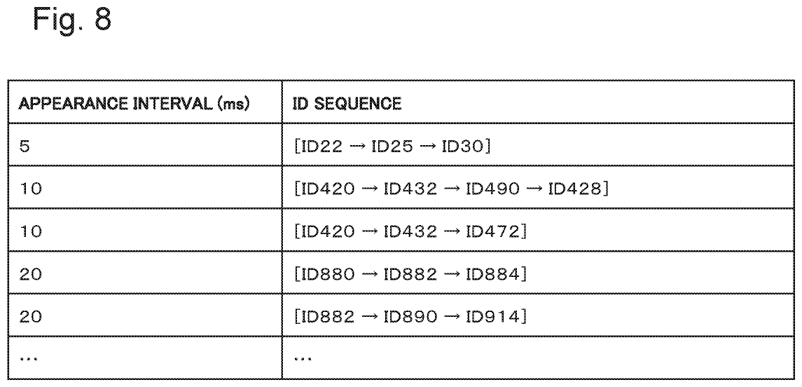

The sequence extracting unit 112 extracts an ID sequence by performing a matrix operation that uses a directed graph for each ID set having the same appearance interval, and generates an ID sequence set. FIG. 8 is a diagram illustrating one example of ID sequence sets indicating sequential relations among message IDs. As illustrated as an appearance interval of 10 ms in FIG. 8, two ID sequences having the same appearance interval may be in some cases extracted as a result of ID sequence extraction.

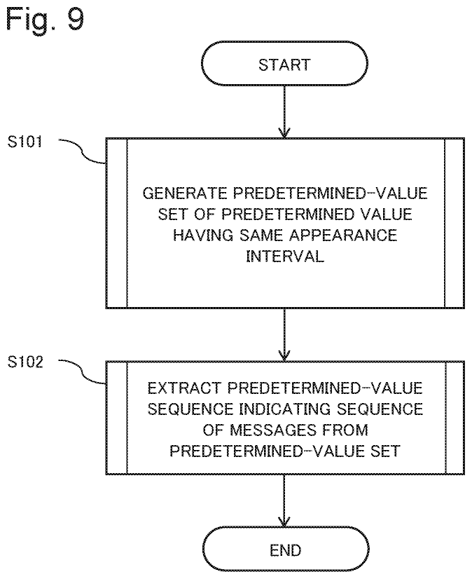

An operation of the extracting device according to the first example embodiment will be described by using drawings. FIG. 9 is a flowchart illustrating an operation of the extracting device according to the first example embodiment.

Based on a predetermined value identifying a message and an appearance interval of the predetermined value that is derived from the timestamp of the message, the interval analysis unit 111 generates a predetermined-value set of predetermined value having the same appearance interval (step S101). For example, the interval analysis unit 111 generates an ID set of message IDs of messages appearing from each node at the same intervals.

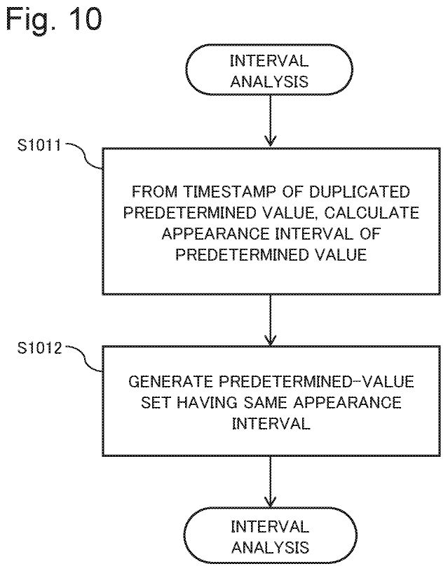

FIG. 10 is a flowchart illustrating an operation of processing of generating a predetermined-value set in step S101. From a timestamp of a duplicated predetermined value, the interval analysis unit 111 calculates an appearance interval of the predetermined value, as predetermined-value set generation processing (step S1011). For example, the interval analysis unit 111 checks whether there is a duplicated message ID in the message log and, when there is a duplicated message ID, calculates a message ID appearance interval of each duplicated message ID from the elapsed time indicated by the timestamp.

Further, the interval analysis unit 111 generates a predetermined-value set having the same appearance interval (step S1012). For example, the interval analysis unit 111 calculates an appearance interval of each of message IDs contained in the message log in series, and generates an ID set into which the message ID is classified by the same appearance interval.

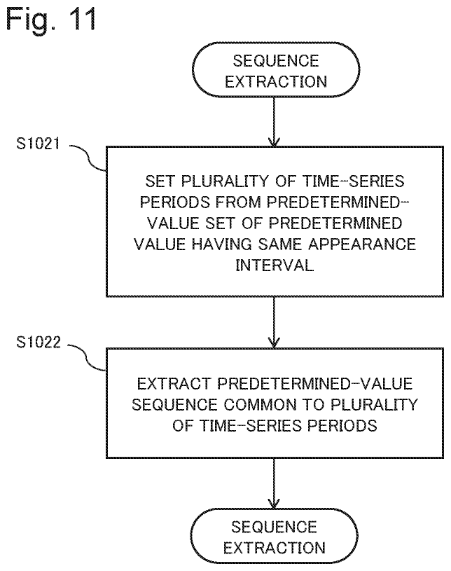

Then, after step S101, the sequence extracting unit 112 extracts a predetermined-value sequence indicating a sequence of messages from the predetermined-value set, as sequence extraction processing (step S102). For example, the sequence extracting unit 112 extracts an ID sequence indicating a sequential relation among messages, from the ID set generated by the interval analysis unit 111. FIG. 11 is a flowchart illustrating an operation of the predetermined-value sequence extraction processing in step S102.

The sequence extracting unit 112 sets a plurality of time-series periods from the predetermined-value set of predetermined value having the same appearance interval (step S1021). For example, the sequence extracting unit 112 sets a plurality of time-series periods from an ID set of message IDs having the same appearance interval in accordance with the number of kinds of IDs included in the ID set. Then, the sequence extracting unit 112 extracts a predetermined-value sequence that is common to the plurality of time-series periods (step S1022). For example, the sequence extracting unit 112 extracts an ID sequence that is common to the plurality of set time-series periods.

Specifically, the sequence extracting unit 112 generates a matrix of a directed graph in which an ID is represented by a vertex and a sequence of the IDs is represented by an edge directed toward the vertex. In the matrix of the directed graph, when a row ID exists before a column ID, the matrix element is set as 1, whereas when a row ID exists after a column ID, the matrix element is set as 0. Note that when a row ID and a column ID are identical to each other, the matrix element is defined as 0. The other matrix elements and matrix elements corresponding to the other time-series periods are defined in a similar way. Then, the sequence extracting unit 112 calculates a directed graph of a normal state in which the sequence of IDs is maintained in the plurality of time-series periods, by the logical product of matrix elements in the three time-series periods. Note that in the more time-series periods, the lower the probability that a matrix element component in a graph of the normal state will be 1 by chance.

Lastly, the sequence extracting unit 112 obtains a matrix of a graph excluding redundant matrix elements from the matrix representation of the graph indicating the normal state, and extracts an ID sequence that is common to the plurality of time-series periods.

The sequence extracting unit 112 extracts an ID sequence by a matrix operation using a directed graph for each ID set that has the same appearance interval, and generates an ID sequence set.

When an ID sequence that is common to a plurality of time-series periods is extracted in the sequence extraction processing according to the first example embodiment, another approach may be used by using a matrix of a directed graph in which an ID is represented by a vertex and an ID sequence is represented by an edge of a path directed toward the vertex. For example, an ID sequence can be extracted by using Prefix-Span or Apriori-All with a smaller amount of computation than that is required for extracting an ID sequence with a certainty factor of 100%.

The extracting device according to the first example embodiment is capable of extracting a sequential relation among messages from a message log in which the sequences of messages are unknown.

### Second Example Embodiment

One aspect of an abnormality detecting device according to a second example embodiment will be described next by using drawings. The abnormality detecting device according to the second example embodiment is an example of an abnormality detecting device that uses the extracting device according to the first example embodiment. In the second example embodiment, a configuration that is the same as the configuration according to the first example embodiment is given the same reference sign, and detailed description thereof will be omitted.

As in the first example embodiment, it is assumed in the second example embodiment that messages are broadcasted from a plurality of nodes connected to a network and do not simultaneously flow on the network. A message log is a history of messages transmitted by each node. It is assumed the message log contained messages transmitted from each node at constant intervals. Further, it is assumed that a sequential relation among the messages in the message log is unknown.

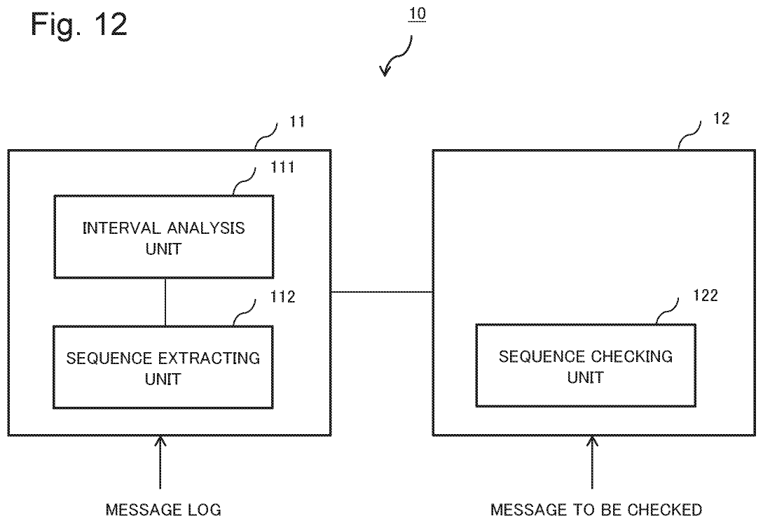

FIG. 12 is a block diagram illustrating a configuration of the abnormality detecting device according to the second example embodiment. The abnormality detecting device 10 illustrated in FIG. 12 includes an extracting device 11 and a checking device 12. It is assumed that the checking device 12 is capable of acquiring an ID sequence set generated by the extracting device 11. The extracting device 12 according to the second example embodiment has a configuration similar to that of the extracting device 11 according to the first example embodiment, and therefore detailed description thereof will be omitted. In the following description of the second example embodiment, an example will be described in which a message ID is used as a predetermined value identifying a message, as in the first example embodiment.

As illustrated in FIG. 12, the checking device 12 includes a sequence checking unit 122. The sequence checking unit 122 has a function of checking whether a sequence of a predetermined value of a message to be checked satisfies an extracted predetermined-value sequence. For example, the sequence checking unit 122 acquires message IDs of messages to be checked in series, and checks whether the sequence of the acquired message ID satisfies an ID sequence extracted by the extracting device 11. It is assumed in the second example embodiment that messages to be checked by the checking device 12 are messages that are flowing on a network that correspond to the message log of the first example embodiment.

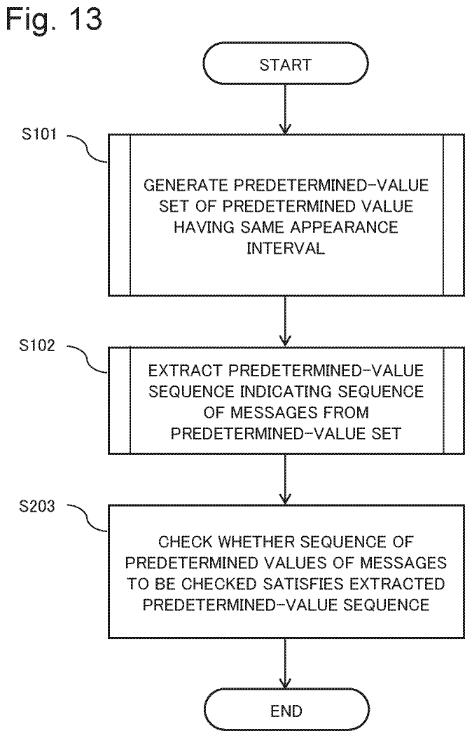

An operation of the abnormality detecting device according to the second example embodiment will be described by using drawings. FIG. 13 is a flowchart illustrating an operation of the abnormality detecting device according to the second example embodiment. In FIG. 13, step S101 and step S102 representing an operation of the extracting device 11 according to the second example embodiment are similar to the operation of the extracting device 11 according to the first example embodiment, and therefore detailed description thereof will be omitted. Note that an example of an operation after the checking device 12 acquired an ID sequence set generated by the extracting device 11 will be described below.

The sequence checking unit 122 of the checking device 12 checks whether a sequence of predetermined values of messages to be checked satisfies an extracted predetermined-value sequence (step S203). For example, the sequence checking unit 122 acquires message IDs to be checked in series, and checks whether the sequence of the message IDs to be checked satisfies the extracted ID sequence. Note that the messages to be checked that the checking device 12 acquires in series may be acquired by the abnormality detecting device 10 including the checking device 12, from the network, or messages to be checked may be acquired from another device.

An operation of the checking device 12 will be described below. Specifically, the description is presented using an example in which the checking device 12 acquires ID sequence sets illustrated in FIG. 8 from the extracting device 11. When acquired message IDs are ID 420 followed by ID 490, the sequence checking unit 122 determines that the sequence of the message IDs to be checked is normal, based on an ID sequence [ID420→ID 432→ID 490→ID 428] which has an appearance interval of 10 ms, illustrated in FIG. 8.

When message IDs to be checked are ID 490 followed by ID 420, the sequence checking unit 122 determines that the sequence of ID 490 and ID 420 is abnormal.

The abnormality detecting device according to the second example embodiment is capable of detecting an abnormality of a sequence of messages, even in a message log in which sequences of messages are unknown. The reason is that the extracting device 11 of the abnormality detecting device 30 extracts an ID sequence of messages from the message log in which sequences of messages are unknown, and the checking device 12 is capable of detecting an abnormality of a sequence of messages by using the extracted ID sequence.

### Third Example Embodiment

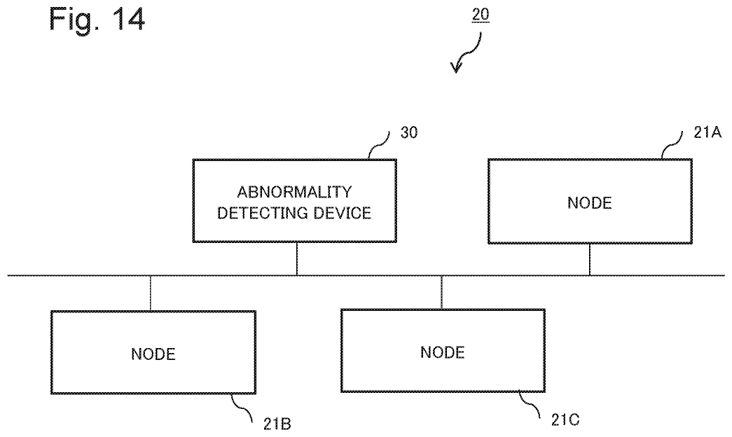

One aspect of an abnormality detecting system and an abnormality detecting device according to a third example embodiment will be described by using drawings. An abnormality detecting system 20 illustrated in FIG. 14 includes an abnormality detecting device 30 and a plurality of nodes 21. The abnormality detecting device 30 and the nodes 21 are connected with each other through a bus to form a network.

Each of the nodes 21 (referred as collective designation of node 21A, node 21B, and node 21C) broadcasts a message to the abnormality detecting device 30 and the other nodes 21. Note that the nodes 21 are controlled to transmit in such a way that a plurality of messages do not simultaneously flow through the bus. One example of the nodes 21 is an electronic control unit (ECU) connected to an in-vehicle local area network (LAN) that conforms to a communication protocol control area network (CAN). It is assumed that the nodes 21 transmit a plurality of messages, and transmit messages periodically or inconstantly. Further, each of the messages contains at least an identifier (ID) of the message. In the following description of the third example embodiment, an example will be described in which a message ID is used as a predetermined value identifying a message.

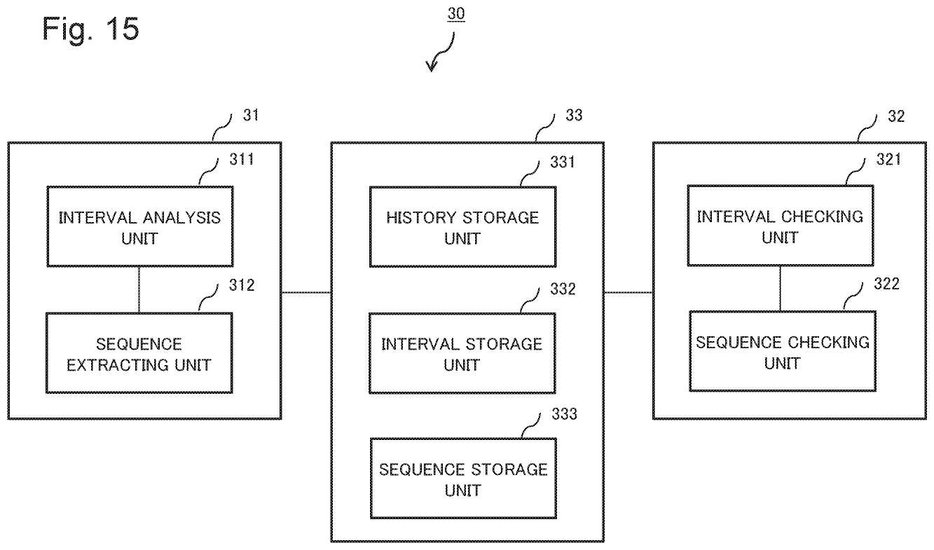

The abnormality detecting device according to the third example embodiment will be described by using drawings. FIG. 15 is a block diagram illustrating a configuration of the abnormality detecting device according to the third example embodiment. The abnormality detecting device 30 illustrated in FIG. 15 includes an extracting device 31, a storage device 33, and a checking device 32.

The extracting device 31 includes an interval analysis unit 311 and a sequence extracting unit 312. The storage device 33 includes a history storage unit 331, an interval storage unit 332, and a sequence storage unit 333. The checking device 32 includes an interval checking unit 321 and a sequence checking unit 322.

The extracting device 31 has a function similar to the function of the extracting device according to the first example embodiment. Detailed description of the same function as that of the extracting device according to the first example embodiment will be omitted from the following description. The extracting device 31 refers to a message log saved in the history storage unit 331, and extracts an ID sequence of message IDs contained in the message log. The extracting unit 31 records the result of the extraction in the sequence storage unit 333.

The extracting device 31 will be described next. Messages transmitted from each of nodes 21 are saved in the history storage unit 331 by an acquisition unit (not illustrated) of the abnormality detecting device 30. The message log saved in the history storage unit 331 is, for example, the message log illustrated in FIG. 2. The message log contains a message ID of message received by the abnormality detecting device 30 from the nodes 21 and timestamp. In the timestamp, an elapsed time (ms) from the start of message reception by the abnormality detecting device 30 is stored. Information other than the message ID and the timestamp may be contained in the message log.

The interval analysis unit 311 checks whether there is a same message ID in the message log in the history storage unit 331, and, when there is the same message ID, derives and analyzes an appearance interval of the message ID. The derivation of the appearance interval is similar to that described in the first example embodiment, and therefore detailed description thereof will be omitted. The analysis is performed when a predetermined number of the same message ID or more (for example 1000 or more) are accumulated in the history storage unit 331.

When the analysis of the appearance interval of message ID represents that there is the same message ID that has the same appearance interval, the interval analysis unit 311 records the message ID and the appearance interval thereof in the interval storage unit 332 in association with each other. The interval analysis unit 311 saves a message ID that has a different appearance interval in the interval storage unit 332 as an inconstant message ID without a constant value.

Information saved in the interval storage unit 332 is an ID set of message IDs classified by an appearance interval, and a message ID that does not have the same appearance interval is saved as being inconstant. The information saved in the interval storage unit 332 is, for example, the ID set classified by appearance interval illustrated in FIG. 3.

Note that a condition on which the interval analysis unit 311 determines that the appearance interval of a message ID is the same is provided to the interval analysis unit 311 in advance, and when the average of appearance intervals of 1000 times of the same message ID is 10 ms and differences from the average are all less than or equal to 2 ms, the interval analysis unit 311 determines that they are the message ID having the same appearance interval.

The sequence extracting unit 312 has a function of extracting an ID sequence, when there is regularity relating to an ID sequence for an ID set of message IDs classified by appearance interval. Specifically, the sequence extracting unit 312 analyzes whether a predetermined ID sequence always holds for an ID set of message IDs having the same appearance interval. For example, when messages with ID 22, ID 25, and ID 30 are transmitted always in this order, this sequence is saved in the sequence storage unit 333.

Extraction of an ID sequence by the sequence extracting unit 312 will be described next by using a specific example. The sequence extracting unit 312 refers to the interval storage unit 332, and, when a plurality of IDs have the same appearance interval, the sequence extracting unit 312 determines to extract the ID sequence of the IDs.

An example is taken in which ID 420, ID 422, ID 427, ID 428, ID 432, ID 472, ID 476, ID 490, ID 493, and ID 507 are recorded in the interval storage unit 332 as having the same appearance interval (for example, 10 ms). Based on this information, the sequence extracting unit 312 first extracts only the messages having these IDs from the record in the history storage unit 331.

Then, the sequence extracting unit 312 selects one of the IDs (for example ID 420), and extracts a time-series period that starts with ID 420 and ends with ID 420, from the ID set. The example of the extraction of the time-series period that starts with ID 420 and ends with ID 420 is similar to the extraction of the time-series period illustrated in FIG. 4. The sequence extracting unit 312 extracts a plurality of time-series periods from the ID set.

For example, the sequence extracting unit 312 extracts ID sequences [ID 420→ID 432→ID 490→ID 428] and [ID 420→ID 432→ID 472] in time-series periods 1, 2 and 3 of an appearance interval of 10 ms, and records the result in the sequence storage unit 333. The result of the extraction recorded in the sequence storage unit 333 is information as illustrated in FIG. 8, for example. In this way, the sequence extracting unit 312 records in the form of a set of IDs and time periods of appearance intervals shared by the IDs.

The storage device 33 includes the history storage unit 331, the interval storage unit 332, and the sequence storage unit 333.

The history storage unit 331 stores a message log from activation to the present time. This is a set of a transmission time and an ID of message. The number of kinds of IDs depends on a protocol of the network. Alternatively, the history storage unit 331 saves a result of analysis by the extracting device 31.

The interval storage unit 332 stores an appearance interval of each ID. For ID that does not have constant appearance interval, the interval storage unit 332 records that appearance interval is inconstant.

The sequence storage unit 333 stores a set of IDs transmitted in a constant sequence maintained that are extracted by a constant sequence ID extracting unit. Because the extraction of the constant sequence set is performed for ID that has the same appearance interval period, the extracted set and the appearance interval are recorded in the sequence storage unit.

The checking device 32 refers to an ID sequence of messages or normal state information indicating constant appearance interval of message ID that are saved in the storage device 33, and checks whether a message ID newly transmitted from a node satisfies the normal state.

The interval checking unit 321 detects an abnormality of a received message, by using an appearance interval of message ID. Specifically, for each message, the interval checking unit 321 refers, from a result of analysis by the interval analysis unit 311, to whether an ID is an ID that is transmitted at constant appearance intervals. When the ID is an ID that is transmitted at constant intervals, the interval checking unit 321 checks whether the appearance interval of the previously transmitted same ID is equal to the appearance interval of the ID analyzed by the interval analysis unit 311. When the appearance interval is not equal, the interval checking unit 321 determines that there is an abnormality.

The sequence checking unit 322 detects an abnormality, based on an appearance sequence of message IDs. The sequence checking unit 322 checks whether an ID sequence relation saved in the sequence storage unit 333 is satisfied. For example, in the case where it is analyzed that the sequence of messages with ID 22, ID 25, and ID 30 is constant, the sequence checking unit 322 checks, when the message with ID 30 is transmitted, whether the message with ID 25 is received after the message with ID 22. When the message with ID 30 is transmitted before transmission of the message with ID 25 after transmission of the message with ID 22, the sequence is abnormal. The sequence checking unit 322 checks whether there is such an abnormality. When there is an abnormality, the sequence checking unit 322 determines that there is an abnormality.

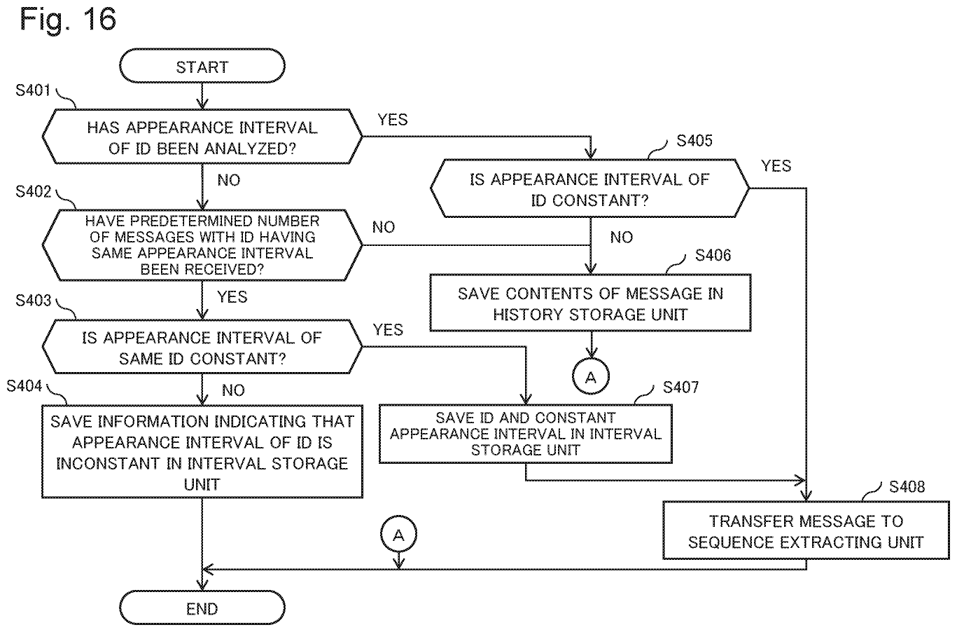

An operation of the abnormality detecting device according to the third example embodiment will be described next by using a drawing. An operation of the interval analysis unit 311 of the extracting device 31 will be described first by using a drawing. FIG. 16 is a flowchart illustrating an operation of the interval analysis unit. In the figure, a message ID may be sometimes simply denoted as ID.

Based on a message ID received by the abnormality detecting device 30, the interval analysis unit 311 checks whether an appearance interval of the message ID has been analyzed (step S401). Specifically, the interval analysis unit 311 checks whether there is a result of analysis of an appearance interval of the received message ID in the interval storage unit 332. The result of the analysis indicates groups of IDs of messages that appear at constant intervals and are classified by appearance interval (see FIG. 3).

When the appearance interval of the message ID has not been analyzed (No in step S401), the interval analysis unit 311 determines whether a sufficient number of the received message ID to analyze an appearance interval of the message ID are stored in a reception history in the history storage unit 331.

When a predetermined number of messages with the ID that have the same appearance interval have been received (Yes in step S402), the interval analysis unit 311 analyses whether the appearance interval of the received message ID is constant (step S405).

On the other hand, when there is an analysis result in the interval storage unit 332 and the appearance interval of the message ID has been analyzed (Yes in step S401), the interval analysis unit 311 checks whether the appearance interval of the message ID is constant for the received messages (step S405).

On the other hand, in step S402, when a predetermined number of messages with the same message ID have not been received (No in step S402), and when the appearance interval of the message ID is not constant (No in step S405), the interval analysis unit 311 saves contents of the received message in the history storage unit 331 (step S406).

When the appearance interval of the message ID is not constant (No in step S403), the interval analysis unit 311 saves information indicating that the appearance interval of the message ID is not constant but inconstant in the interval storage unit 332 (step S404).

Further, in step S403, when the appearance interval of the message ID is constant (Yes in step S403), the interval analysis unit 311 saves the message ID and the constant appearance interval corresponding to the message ID, in the interval storage unit 332, in association with each other (step S407).

When it is determined that the appearance interval of the message ID is constant (Yes in step S405), and after the processing in step S407, the interval analysis unit 311 transfers the message to the sequence extracting unit 312 (step S408).

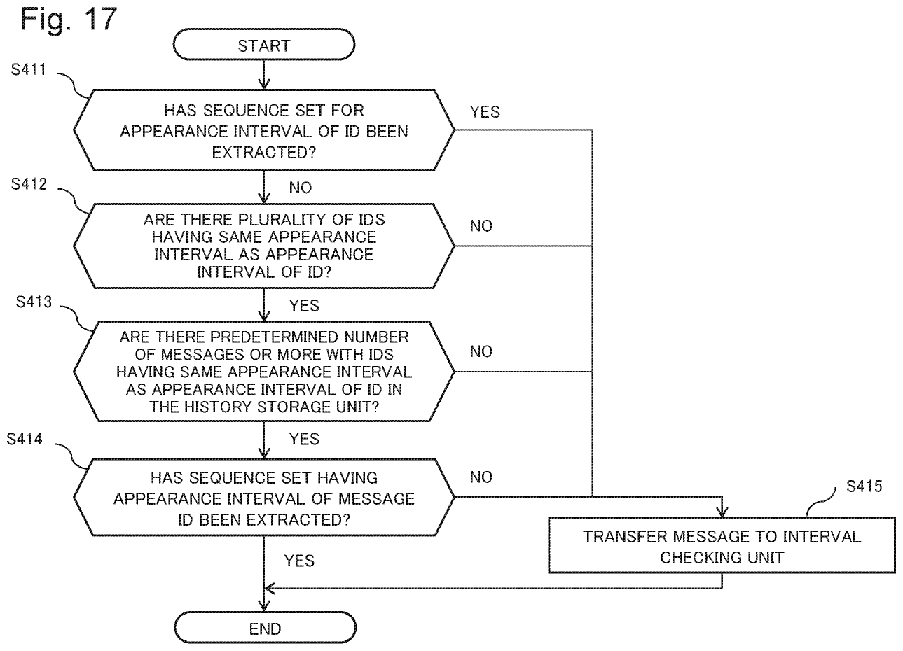

An operation of the sequence extracting unit 312 of the extracting device 31 will be described below by using a drawing. FIG. 17 is a flowchart illustrating an operation of the sequence extracting unit.

### (Operation of Sequence Extracting Unit)

The sequence extracting unit 312 checks the sequence storage unit 333 to see whether an ID sequence set has been extracted for an appearance interval of a message ID (step S411).

When an ID sequence set has not been extracted (No in step S411), the sequence extracting unit 312 checks the interval storage unit 332 to see whether there are a plurality of IDs that have the same appearance interval as the appearance interval of the ID of a message (step S412).

When there are a plurality of IDs that have the same appearance interval as the appearance interval of the ID of the message (Yes in step S412), the sequence extracting unit 312 checks the history storage unit 331 to see whether there are a predetermined number of messages or more with IDs that have the same appearance interval as the appearance interval of the IDs (step S413).

When there are a predetermined number of messages or more in the history storage unit 331 (Yes in step S413), the sequence extracting unit 312 extracts an ID set of IDs that have the same appearance interval (step S414), and stores the result of the extraction in the sequence storage unit 333.

When a constant sequence ID set has been extracted (Yes in step S411), when there are not a plurality of IDs that have the same appearance interval as the appearance interval of the ID (No in step S412), when there are not the predetermined number of messages or more that meet the condition in the history storage unit 331 (step S413), and when the processing in step S414 ends (No in step S414), then the sequence extracting unit 312 transfers the received message to the interval checking unit 321.

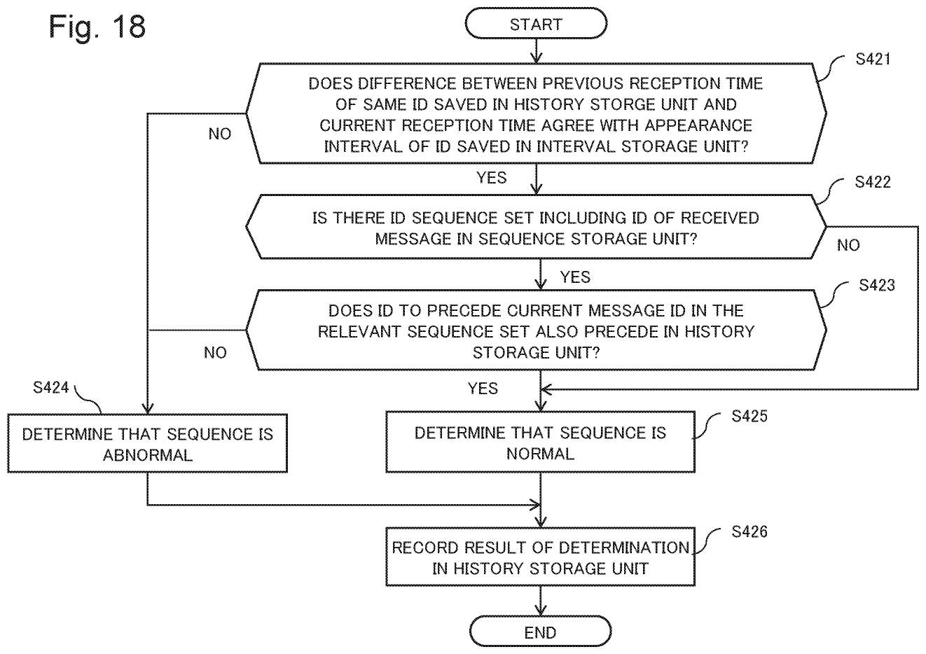

An operation of the checking device 32 will be described by using a drawing. FIG. 18 is a flowchart illustrating an operation of the checking device.

The interval checking unit 321 checks whether a time difference between the previous reception time of a message with the same ID as a message saved in the history storage unit 331 and the present agrees with an appearance interval of an ID stored in the interval storage unit 332 (step S421).

When it agrees with the appearance interval of the ID (Yes in step S421), the sequence checking unit 322 checks whether there is an ID sequence set that includes the ID of the message in the sequence storage unit 333 (step S422).

When there is such an ID sequence set (Yes in step S422), the sequence checking unit 322 checks whether an ID to precede the current message ID, in the relevant ID sequence set, has been also received before the message ID in storage in the history storage unit 331 (step S423).

When there is not an ID sequence set including the ID of the received message (No in step S422), and when a message to be received before the current message ID has been received, the sequence checking unit 322 determines that the sequence is normal (step S425).

When the difference between the previous reception time of the message with the same ID as the received message and the current reception time does not agree with the appearance interval of the ID stored in the interval storage unit 332 (No in step S421), and when the ID to precede the current message ID is not stored in the history storage unit 331 (No in step S423), the sequence checking unit 322 determines that it is abnormal (step S424).

After the processing in step S424 and the processing in step S425, the sequence checking unit 322 saves the result of the determination in the history storage unit 331 (step S426).

The abnormality detecting device according to the third example embodiment is capable of performing abnormality detection based on a message interval, in addition to abnormality detection based on a message sequence, and therefore is capable of improving the accuracy of abnormality detection of a message.

### Modification Example of First to Third Example Embodiments

A topology of a network through which messages flow can also be applied to other network topologies such as star type, mesh type and ring type, in addition to a bus type used in a CAN.

In the foregoing description, examples are used in which messages are broadcasted from a plurality of nodes connected to a network, the present invention is not limited to this. For example, the present invention is also applicable to an example of messages that are unicasted from a node, for example.

While the description is provided by using examples of messages on an in-vehicle CAN network, the present invention is not limited to this. For example, the present invention is also applicable to other network system such as industrial network, in addition to in-vehicle network.

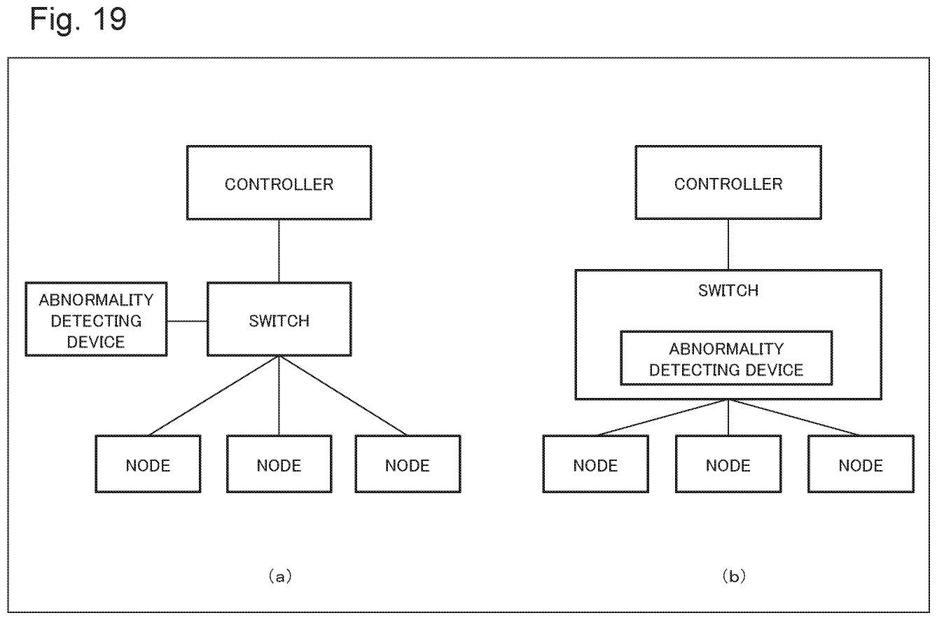

FIG. 19 is a block diagram illustrating an example of the abnormality detecting device applied to another network system. Each of the network systems in FIG. 19 includes a plurality of nodes, a switch, and a controller, and the switch transfers a message input into the switch to nodes in response to an instruction from the controller. As illustrated in (a) of FIG. 19, a configuration may be made in which the abnormality detecting device is connected to the switch and the abnormality detecting device detects an abnormality of a message input into the switch. Further, as illustrated in (b) of FIG. 19, a configuration may be made in which the abnormality detecting device is disposed inside the switch. A configuration may be made in which the checking device is disposed inside a switch and the extracting device is disposed outside the switch.

Information other than a timestamp and a message ID may be contained in the message logs described in the first to third example embodiments, for example, data of messages may be contained. Further, a message log may be configured to be stored in a temporary storage device (for example, a RAM).

### (Hardware Configuration)

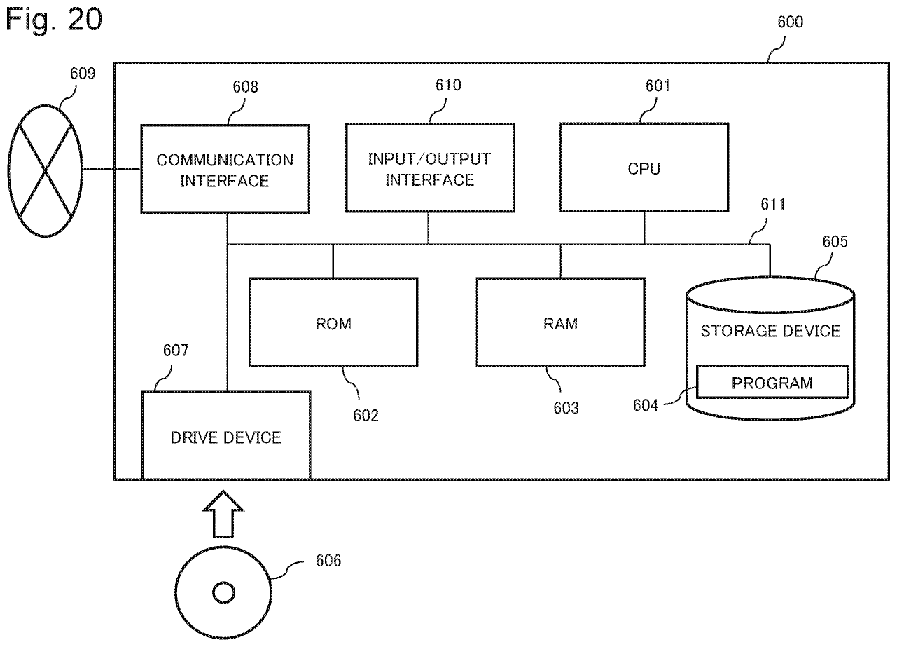

FIG. 20 is a diagram illustrating a hardware configuration that achieves the extracting device according to any of the first to third example embodiments or the detecting device and the abnormality detecting device according to any of the second and third example embodiments, by a computer. Each of the components of the extracting device, the checking device, or the abnormality detecting device according to the first to third example embodiments are described in functional blocks. Part or all of each of the components of the extracting device, the checking device, or the abnormality detecting device are achieved by any combination of a computer and a program as illustrated in FIG. 20, for example. By way of one example, the computer includes the following configuration:

### a Central Processing Unit (CPU) 601,

### a Read Only Memory (ROM) 602,

### a Random Access Memory (RAM) 603,

a program 604 loaded into the RAM 603,
a storage device 605 that stores the program 604,
a drive device 607 that reads from and writes to a storage medium 606,
a communication Interface 608 that connects to a communication network 609,
an input/output interface 610 for inputting and outputting data, and
a bus 611 that connects each of the components.

Each of the components of the extracting device, the checking device, or the abnormality detecting device are achieved by the CPU 601 acquiring and executing the program 604 that achieves the function of the components. The program 604 that achieves the function of each of the components is stored in the storage device 605, the ROM 602, or the RAM 603, for example, in advance, and is read by the CPU 601 as necessary. Note that the program 604 may be provided to the CPU 601 via the communication network 609, or may be stored in the storage medium 606 in advance, and the drive device 607 may read out the program, and provide the program to the CPU 601.

There are various modification examples of the method of achieving the extracting device, the checking device, or the abnormality detecting device. For example, each of the components of the extracting device, the checking device, or the abnormality detecting device may be achieved by any combination of a discrete computer and a program. Further, a plurality of components provided in the extracting device, the checking device, or the abnormality detecting device may be achieved by any combination of one computer and a program.

Further, part or all of each of the components of the extracting device, the checking device, or the abnormality detecting device are achieved by other general-purpose or dedicated circuits, processors, or the like, or a combination thereof. They may consist of a single chip, or may consist of a plurality of chips connected via a bus. Further, instead of a computer, a programmable logic device such as field-programmable gate array (FPGA) may be used.

Further, part or all of each of the components of the extracting device, the checking device, or the abnormality detecting device may be achieved by a combination of the circuits or the like mentioned above and a program.

Further, when part or all of each of the components of the extracting device, the checking device, or the abnormality detecting device are achieved by a plurality of information processing devices, circuits, or the like, the plurality of information processing devices, circuits, or the like may be centralizedly disposed or may be distributedly disposed. For example, the computer, the circuit, or the like may be achieved in a form such as a client-and-server system, a cloud computing system, or the like, in which they are connected via a communication network.

While the present invention is described with reference to example embodiments, the present invention is not limited to the example embodiments described above. Various modifications that can be understood by those skilled in the art can be made to configurations and details of the present invention within the scope of the present invention.

Part or all of the example embodiments described above can also be described as, but not limited to, the following supplementary notes.

### (Supplementary Note 1)

An extracting device, including:
an interval analysis means for, based on a predetermined value identifying a message and an appearance interval of the predetermined value that is derived from a timestamp of the message, generating a predetermined-value set of the predetermined value that appears at the same appearance intervals; and a sequence extracting means for extracting a predetermined-value sequence indicating a sequence of the messages from the predetermined-value set.

### (Supplementary Note 2)

The extracting device according to supplementary note 1, wherein the sequence extracting means sets a plurality of time-series periods from the predetermined-value set, based on the number of the identified predetermined values included in the predetermined-value set, and extracts the predetermined-value sequence being common to the plurality of time-series periods.

### (Supplementary Note 3)

The extracting device according to supplementary note 1 or 2, wherein the predetermined value is an integer being an abstraction of a combination of a message ID and data of a message, a destination and data, a command and data, or two pieces of data, or an identifier identifying a message.

### (Supplementary Note 4)

The extracting device according to any one of supplementary notes 1 to 3, wherein the sequence extracting means extracts the predetermined-value sequence by using a directed graph in which the predetermined value in the time-series period is represented by a vertex and a sequence of the predetermined values is represented by an edge.

### (Supplementary Note 5)

An extracting method, including:
based on a predetermined value identifying a message and an appearance interval of the predetermined value that is derived from a timestamp of the message, generating a predetermined-value set of the predetermined value that appears at the same appearance intervals; and extracting a predetermined-value sequence indicating a sequence of the messages from the predetermined-value set.

### (Supplementary Note 6)

An extraction program causing a computer to execute:
based on a predetermined value identifying a message and an appearance interval of the predetermined value that is derived from a timestamp of the message, generating a predetermined-value set of the predetermined value that appears at the same appearance intervals; and extracting a predetermined-value sequence indicating a sequence of the messages from the predetermined-value set.

### (Supplementary Note 7)

An abnormality detecting device, including:

the extracting device according to any one of supplementary notes 1 to 4; and

a checking device, wherein

the checking device includes a sequence checking means for checking whether a sequence of a predetermined value of a message to be checked satisfies the predetermined-value sequence extracted by the extracting device.

### (Supplementary Note 8)

The abnormality detecting device according to supplementary note 7, wherein

the checking device further includes an interval checking means for checking whether an appearance interval of a predetermined value of the message to be checked is identical to an appearance interval of a particular predetermined value in the predetermined-value set.

### (Supplementary Note 9)

An abnormality detecting method, including:

extracting the predetermined-value sequence by the extracting method according to supplementary note 5; and

checking whether a sequence of a predetermined value of a message to be checked satisfies the predetermined-value sequence.

### (Supplementary Note 10)

An abnormality detecting system, including:

a plurality of nodes that transmit a message; and

the abnormality detecting device according to supplementary note 7 or 8.

This application is based upon and claims the benefit of priority from Japanese Patent Application No. 2017-007835, filed on Jan. 19, 2017, the disclosure of which is incorporated herein in its entirety by reference.

### REFERENCE SIGNS LIST

10 Abnormality detecting device
11 Extracting device
12 Checking device
20 Abnormality detecting system
21, 21A, 21B, 21C Node
30 Abnormality detecting device
31 Extracting device
32 Checking device
33 Storage device
111 Interval analysis unit
112 Sequence extracting unit
122 Sequence checking unit
311 Interval analysis unit
312 Sequence extracting unit
321 Interval checking unit
321 Interval checking unit
322 Sequence checking unit
331 History storage unit
332 Interval storage unit
333 Sequence storage unit
601 CPU
602 ROM
603 RAM
604 Program
605 Storage device
606 Storage medium
607 Drive device
608 Communication interface
609 Communication network
610 Input/output interface
611 Bus

What is claimed is:

1. An extracting device, comprising:
at least one memory configured to store instructions and;
at least one processor configured to execute the instructions to:
based on a predetermined value identifying a message and an appearance interval of the predetermined value that is derived from a timestamp of the message, generate a predetermined-value set of the predetermined value that appears at the same appearance intervals; and
extract a predetermined-value sequence indicating a sequence of the messages from the predetermined-value set.

2. The extracting device according to claim 1, wherein
the at least one processor configured to execute the instructions to
set a plurality of time-series periods from the predetermined-value set, based on a number of the identified predetermined values included in the predetermined-value set, and extract the predetermined-value sequence being common to the plurality of time-series periods.

3. The extracting device according to claim 1, wherein
the predetermined value is an integer being an abstraction of a combination of a message ID and data of a message, a destination and data, a command and data, or two pieces of data, or an identifier identifying a message.

4. The extracting device according to claim 2, wherein
the at least one processor configured to execute the instructions to
extract the predetermined-value sequence by using a directed graph in which the predetermined value in the time-series period is represented by a vertex and a sequence of the predetermined values is represented by an edge.

5. An extracting method, comprising:
based on a predetermined value identifying a message and an appearance interval of the predetermined value that is derived from a timestamp of the message, generating a predetermined-value set of the predetermined value that appears at the same appearance intervals; and
extracting a predetermined-value sequence indicating a sequence of the messages from the predetermined-value set.

6. A non-transitory computer readable storage medium storing an extraction program causing a computer to execute:
based on a predetermined value identifying a message and an appearance interval of the predetermined value that is derived from a timestamp of the message, generating a predetermined-value set of the predetermined value that appears at the same appearance intervals; and
extracting a predetermined-value sequence indicating a sequence of the messages from the predetermined-value set.

7.-10. (canceled)

11. The extracting device according to claim 2, wherein
the predetermined value is an integer being an abstraction of a combination of a message ID and data of a message, a destination and data, a command and data, or two pieces of data, or an identifier identifying a message.

12. The extracting method according to claim 5, comprising:
setting a plurality of time-series periods from the predetermined-value set, based on a number of the identified predetermined values included in the predetermined-value set, and;
extracting the predetermined-value sequence being common to the plurality of time-series periods.

13. The extracting method according to claim 5, wherein
the predetermined value is an integer being an abstraction of a combination of a message ID and data of a message, a destination and data, a command and data, or two pieces of data, or an identifier identifying a message.

14. The extracting method according to claim 12, comprising extracting the predetermined-value sequence by using a directed graph in which the predetermined value in the time-series period is represented by a vertex and a sequence of the predetermined values is represented by an edge.

15. The non-transitory computer readable storage medium according to claim 6, the extraction program causing the computer to execute:
setting a plurality of time-series periods from the predetermined-value set, based on a number of the identified predetermined values included in the predetermined-value set, and;
extracting the predetermined-value sequence being common to the plurality of time-series periods.

16. The non-transitory computer readable storage medium according to claim 6, wherein
the predetermined value is an integer being an abstraction of a combination of a message ID and data of a message, a destination and data, a command and data, or two pieces of data, or an identifier identifying a message.

17. The non-transitory computer readable storage medium according to claim 15, the extraction program causing the computer to execute:
extracting the predetermined-value sequence by using a directed graph in which the predetermined value in the time-series period is represented by a vertex and a sequence of the predetermined values is represented by an edge.
